(19) United States
(12) Patent Application Publication
(10) Pub. No.: US 2014/0339479 A1
(43) Pub. Date: Nov. 20, 2014

(54) FLAKE-FORM CONDUCTIVE FILLER

(71) Applicant: TOYO ALUMINIUM KABUSHIKI KAISHA, Osaka-shi, Osaka (JP)

(72) Inventors: Kazunori Koike, Osaka-shi (JP); Miki Fujii, Osaka-shi (JP); Hideaki Minamiyama, Osaka-shi (JP); Kazuya Minami, Osaka-shi (JP)

(21) Appl. No.: 14/370,390

(22) PCT Filed: Jan. 10, 2013
(86) PCT No.: PCT/JP2013/050270

§ 371 Date: Jul. 2, 2014

(30) Foreign Application Priority Data
Jan. 20, 2012 (JP) 2012-010091

(51) Int. Cl. H01B 1/02; H01B 13/00; C23C 18/42; B02C 23/06; B02C 17/00

(52) U.S. Cl. CPC H01B 1/02; B02C 23/06; B02C 17/00; C23C 18/42; H01B 13/0006; H01B 13/0026
USPC 252/514; 241/15

(57) ABSTRACT

The present invention provides a flake-form conductive filler which is easy and low-cost to produce and has a high conductivity. The flake-form conductive filler of the present invention includes a flake-form base material and a silver coating covering the entire surface of the flake-form base material. The flake-form base material contains copper. The flake-form conductive filler has a ratio a/b between a peak intensity “a” derived from a silver (111) plane and a peak intensity “b” derived from a silver (220) plane at 2 or less in the powder X-ray diffraction measurement.

### TECHNICAL FIELD

The present invention relates to a flake-form conductive filler.

### BACKGROUND ART

Conventionally, as a filler for a conductive paste, a silver filler consisting of only silver has been widely used. However, since silver is costly and has a migration property, a silver-coated copper filler having silver coated on the surface of copper powder has been developed as a replacement. The silver-coated copper filler is advantageous over the silver filler consisting of only silver at low cost, improved migration resistance and the like, and advantageous over a copper filer consisting of only copper at oxidation resistance and the like.

As a method of coating silver to the surface of the copper powder constituting the silver-coated copper filler, generally, chemical plating or sputtering is commonly used. Since the silver coating is obtained by depositing or laminating silver on the surface of the copper powder, the silver atoms may not be aligned densely.

As an example of such silver-coated filler, for example, Japanese Patent No. 4677900 (PTD 1) discloses a conductive powder mixture of scaly particles and spherical particles. PTD 1 describes that after the surface of the copper powder is partially coated by silver and an alloy of silver and copper through electroless plating, the surface of the silver-coated copper powder is smoothed in a scaling process, and the scaly silver-coated copper powder obtained thereby is used as the scaly particles. Moreover, PTD 1 describes that the scaling process may be performed on the silver-coated copper powder after the plating by using a mixer, for example a ball mill or the like charged with dispersion beads such as zirconia beads.

Meanwhile, Japanese Patent Laying-Open No. 06-287762 (PTD 2) discloses a method of producing scaly silver-coated copper powder in a manner different from the method of producing the scaly particles in PTD 1. Specifically, in the method described in PTD 2, a silver plating process is performed after the spherical copper powder has undergone the scaling process.

### CITATION LIST

### Patent Document

PTD 1: Japanese Patent No. 4677900

PTD 2: Japanese Patent Laying-Open No. 06-287762

### SUMMARY OF INVENTION

### Technical Problem

In order to further improve the migration effect, the scaly silver-coated copper powder of PTD 1 is not produced by coating silver uniformly on the entire surface of the copper powder but coating silver partially on the entire surface thereof, and hence it is characterized that copper is partially exposed over the surface. However, since copper is exposed over the surface, the conductivity and the temporal stability on the fluidity of ink have a trend to decrease. The reason therefor is considered to be the insufficient oxidation resistance of the partially exposed copper and the gelation caused by the partially exposed copper when it is formulated into the conductive paste.

Further in PTD 1, in order to make the conductive powder high in filling density, a conductive powder mixture of scaly particles and spherical particles is adopted. When the conductive powder mixture is used as a conductive paste, although the conductivity thereof is improved, it takes a lot of time and efforts to prepare the conductive powder mixture. Specifically, it is necessary to go through a step of preparing the scaly particles and the spherical particles separately, a step of adjusting a formulation amount of each of the scaly particles and the spherical particles, and a step of blending the scaly particles and the spherical particles by using a ball mill, a rocking mill, a V-type blender, a vibration mill or the like for about 100 hours so as to prepare the conductive powder mixture, requiring a lot of time and efforts.

On the other hand, in order to obtain the smoothness of the conductive coating, it is necessary to use a silver-coated copper powder which is thin and scaly. However, according to the production method of PTD 2, the specific surface area of the copper powder will increase as the copper powder is made thinner and scaly, hence, it is difficult to ensure good dispersion of the scaly copper powder in a reaction solution in a silver plating process. Therefore, the uniformity of the plating is impaired, which makes it difficult to stably produce a scaly silver-coated copper powder having a high conductivity.

The present invention has been accomplished in view of the aforementioned problems, and it is therefore an object of the present invention to provide a flake-form conductive filler which is easy and low-cost to produce and has a high conductivity.

### Solution to Problem

In order to solve the abovementioned problems, the inventors of the present invention, after intensive researches, have found that a flake-form conductive filler, which is obtained by flaking under certain conditions a silver-coated powder having a silver coating formed on the surface of copper-containing powder, has specific physical properties in the X-ray diffraction measurement and thus can be used to solve the abovementioned problems, and after further investigation on the finding, have achieved the present invention.

Specifically, the flake-form conductive filler according to the present invention includes a flake-form base material and a silver coating covering the entire surface of the flake-form base material. The flake-form base material contains copper, and the flake-form conductive filler has a ratio a/b between a peak intensity “a” derived from a silver (111) plane and a peak intensity “b” derived from a silver (220) plane at 2 or less in the X-ray diffraction measurement.

Preferably, the flake-form conductive filler has an average aspect ratio of an average particle size D₅₀ relative to an average thickness t at 1.5 or more to 500 or less, and more preferably, the flake-form conductive filler has an average aspect ratio greater than 10 and equal to 50 or less. Further, the present invention relates to a conductive paste composition containing the flake-form conductive filler and a conductive product produced by using the conductive paste composition.

Furthermore, the present invention relates to a production method of a flake-form conductive filler including a first step of preparing silver-coated powder which has a silver coating formed on the surface of copper-containing powder, and a second step of flaking the silver coating powder in an organic solvent by using a grinding device equipped with a grinding medium. The grinding medium used in the second step is a spherical medium having a diameter ranging from 0.2 mm or more to 40 mm or less.

Preferably, the silver-coated powder in the first step is obtained by forming a silver coating on the surface of the copper-containing powder through electroless plating and the silver-coated powder is flaked in the second step in the presence of a higher fatty acid. Preferably, the silver-coated powder in the first step is treated with a higher fatty acid after the silver coating is formed through electroless plating on the surface of the copper-containing powder.

### Advantageous Effects Of Invention

The flake-form conductive filler of the present invention is advantageous in that it is easy and low-cost to produce and has a superiorly high conductivity. In other words, since it is not necessary to blend two types of fillers which are different in shape as that in the prior art and thereby neither a long time is needed in the production nor a control is needed for precisely blending the fillers, the flake-form conductive filler according to the present invention is easy and low-cost to produce; and since the entire surface thereof is coated by the silver coating, the flake-form conductive filler according to the present invention has a high conductivity.

### DESCRIPTION OF EMBODIMENTS

Hereinafter, the present invention will be further described in detail.

### Flake-Form Conductive Filler

The flake-form conductive filler of the present invention includes a flake-form base material and a silver coating covering the entire surface of the flake-form base material. The flake-form base material is characterized in that it contains copper, and the flake-form conductive filler of the present invention is characterized in that it has a ratio a/b between a peak intensity “a” derived from a silver (111) plane and a peak intensity “b” derived from a silver (220) plane at 2 or less in the X-ray diffraction measurement.

The flake-form conductive filler of the present invention can include any other components as long as it has a flake-form base material and a silver coating.

### Flake-form Base Material

The flake-form base material of the present invention is characterized in that it contains copper. Specifically, the flake-form base material of the present invention may be formed to contain only copper, or may be formed to contain a composition (copper alloy) which contains copper as a primary metal element and various metal elements other than copper. In addition, an oxide coating may be formed on the surface of the flake-form base material.

### Silver Coating

The silver coating of the present invention is coated on the entire surface of the flake-form base material. Since the flake-form conductive filler of the present invention is enabled with sufficient oxidation resistance, and meanwhile since the gelation is prevented from occurring in the conductive paste, the flake-form conductive filler of the present invention exhibits excellent effect of having improved temporal stability on conductivity. It is considered that the main reason has been that since silver is coated on the entire surface of the flake-form base material, it is difficult for an oxide coating to be formed on the flake-form base material surface, which thereby prevents the conductivity from being degraded by the oxide coating.

Although the thickness of the silver coating is not particularly limited, it is preferable that it is made thinner while maintaining high conductivity on the consideration of economic efficiency. Therefore, the thickness thereof is preferably 5 mm or more to 200 mm or less, and more preferably is 10 mm or more to 100 mm or less.

On the same consideration, the ratio of the content of the silver coating in the flake-form conductive filler is preferred to be 5 to 30 mass % relative to the total mass of the flake-form conductive filler. It should be noted that in the present invention a clear interface (boundary) is not necessarily to be present between the flake-form base material and the silver coating. This is because that the components of the two (silver and copper) may diffuse to each other nearby the boundary of the two. Therefore, even if there is no clear boundary between the two, it does not depart from the scope of the present invention (it cannot be used to deny the presence of the silver coating).

### Intensity Ratio by X-ray Diffraction Measurement

The flake-form conductive filler of the present invention is required to have a ratio a/b between a peak intensity “a” derived from a silver (111) plane and a peak intensity “b” derived from a silver (220) plane at 2 or less in the X-ray diffraction measurement. More preferably, the ratio a/b is 1.5 or less.

It is considered that when the ratio a/b satisfies the above range, the silver atoms in the silver coating covering the surface of the flake-form base material are in an aligned state. Therefore, even though the thickness of the silver coating is made thin, it is expected that the silver coating improves the oxidation resistance of the flake-form base material surface and meanwhile improves the electrical conductivity.

Although the X-ray diffraction measurement as described above can be used to measure the flake-form conductive filler singularly, base on the point that it is possible to analyze the planar portion of the flake-form conductive filler more accurately by performing the X-ray diffraction measurement while the flake-form conductive fillers are being well aligned in the coating film, it is preferable to measure the coating film in which the flake-form conductive fillers are forcibly oriented.

### Average Aspect Ratio or the Like

The average aspect ratio (D₅₀/t) is a ratio of the average particle size (D₅₀) relative to the average thickness (t). Preferably, the average aspect ratio of the flake-form conductive filler of the present invention is 1.5 or more to 500 or less, and more preferably, the average aspect ratio is greater than 10 and equal to 50 or less.

If the average aspect ratio is less than 1.5, the flaking of the silver-coated powder in the second step in the production method to be described hereinafter is insufficient, and thereby, the silver atoms in the silver coating may not be well aligned. On the other hand, if the average aspect ratio is greater than 500, the flaking in the second step will proceed excessively, and thereby, the thickness of the silver coating may become extremely thin, the effects of forming the silver coating may not be obtained, such as the decrease in conductivity may occur. Further, if the average aspect ratio is greater than 500, and such flake-form conductive filler is used to prepare a conductive paste composition, unfavorable problems may occur, such as the viscosity of the conductive paste composition may become excessively high.

The average aspect ratio is calculated by solving the ratio (D₅₀/t) between the average particle size (D₅₀) and the average thickness (t) of the flake-form conductive filler.

The average particle size (D₅₀), also known as the median size, refers to such a particle size that particles having a particle size larger than the median size is present at equal amount to particles having a particle size smaller than the median size. The average particle size (D₅₀) of the flake-form conductive filler according to the present invention is preferably in the range of 1 μm or more to 50 μm or less, and more preferably in the range of 2 μm or more to 20 μm or less.

If the average particle size (D₅₀) is 2 μm or more to 10 μm or less in the range, when it is formulated into the conductive paste composition to draw a pattern such as a circuit, it is possible to cope with fine wires, and thereby such average particle size is preferable. If the average particle size is 10 μm or more to 20 μm or less, in the case of forming a relatively thin coating film on a large area such as an electromagnetic wave shielding, since the flake-form conductive filler is smooth and good in particle continuity, it is effective for obtaining a coating film having high electrical conductivity. Preferably, the average thickness (t) is in the range of 0.05 μm or more to 5 μm or less, and more preferably, the average thickness (t) is in the range of 0.1 μm or more to 2 μm or less. When the flake-form conductive filler is formulated into the conductive paste composition (ink) within this range, it is advantageous in terms of viscosity, coating property, adhesion of the coating film and the like.

The average particle size (D₅₀) described above is obtained by calculating the volume average size from the particle size distribution measured by a known particle size distribution measurement method such as the laser diffraction method. As to the average thickness (t) described above, the cross section of the conductive coating film, which is formed from the conductive paste composition formulated with the flake-form conductive filler, is observed with a scanning electron microscope (SEM), the thickness of a number of 100 randomly selected flake-form conductive fillers is measured to calculate an average value, and the average value is used as the average thickness.

### Applications or the Like

The flake-form conductive filler of the present invention may be used without particular limitation in applications where the conductive filler of this type has been used conventionally.

For example, a conductive paste composition which contains the flake-form conductive filler may be given as an example. More specifically, a conductive resin composition or a conductive coating or a conductive ink or a conductive adhesive agent each of which contains various types of resin, glass frit and the like, or a conductive film which is obtained by blending and kneading the flake-form conductive filler in the resin, for example, may be given as an example of such conductive paste composition.

Moreover, any product which possesses electrical conductivity and is formed by using a conductive paste composition described above may be given as an example.

More specifically, for example, a conductive coating film, an electrode, a wire, a circuit, a conductive bonding structure, a conductive adhesive tape or the like may be given as an example of a product having electrical conductivity.

### Production Method

Although the production method of the flake-form conductive filler according to the present invention is not particularly limited, it is preferable to adopt the following exemplary method.

Specifically, it is preferable to adopt such production method that includes a first step of preparing silver-coated powder which has a silver coating formed on the surface of copper-containing powder and a second step of flaking the silver-coated powder in an organic solvent by using a grinding device equipped with a grinding medium. The grinding medium used in the second step is a spherical medium having a diameter ranging from 0.2 mm or more to 40 mm or less. The production method will be described hereinafter.

### First Step

The first step is a step of preparing the silver-coated powder which has a silver coating formed on the surface of the copper-containing powder. Here, as the copper-containing powder, a powder composed of copper only or a copper alloy which contains copper as a primary metal element and various metal elements other than copper may be used. In addition, an oxide coating may be formed on the surface of the copper-containing powder.

The copper-containing powder is not particularly limited in shape, any copper-containing powder having, for example, a granular shape, a spherical or the like may be used. Preferably, the average particle size (D₅₀) of the copper-containing powder is in the range of 0.5 μm or more to 30 μm or less, and more preferably in the range of 1 or more to 10 μpm or less. In addition, if the thickness is not so small and the aspect ratio is not so large as to impair the effects of the present invention, a copper-containing powder having a plate shape, a flake shape or the like may also be used. Nevertheless, generally, it is difficult for the copper-containing powder having a plate shape, a flake shape or the like to form the silver coating uniformly. Particularly in the case of forming the silver coating through electroless plating, since the specific surface area of the copper-containing powder is increased, it is difficult to ensure good dispersion of the copper-containing powder in the reaction solution for the silver plating treatment, and thereby the uniformity of the plating is impaired, which makes it difficult to obtain a conductive filler having a high conductivity. Base on the above reasons, it is preferable to use a copper-containing powder having a granular shape, a spherical shape or the like.

Meanwhile, the method of forming the silver coating on the surface of the copper-containing powder is not particularly limited, any known method such as CVD (chemical vapor deposition) method, the electrolytic plating method, the electroless plating method, the PVD (physical vapor deposition) method may be adopted. In particular, from the viewpoint of economical efficiency and productivity, the electroless plating method is preferred.

It should be noted that in the flake-form conductive filler according to the present invention, although the entire surface of the flake-form base material is required to be coated with a silver coating, the entire surface of the silver-coated powder in the first step is not needed to be thoroughly covered by the silver coating. In other words, the silver-coated powder may have a portion which is not formed with the silver coating.

This is because that when the silver coating on the surface of the silver-coated powder is flattened in the second step to be described later, the portion which is not covered by the silver coating will be covered by the silver coating through the flattening. Nevertheless, it does not mean to exclude the case where the entire surface of the silver-coated powder is coated with the silver coating.

In addition, as the silver-coated powder, any silver-coated powder which is commercially available may be used directly.

### Second Step

The second step is a step of flaking the silver-coated powder prepared in the first step in an organic solvent by using a grinding device equipped with a grinding medium. In other words, the silver-coated powder is flaked to prepare the flake-form conductive filler. In the present invention, although the step of flaking the silver-coated powder is not particularly limited, it is preferable to use a grinding device equipped with a grinding medium to flake the silver-coated powder in an organic solvent as mentioned in the above.

Thus, the silver-coated powder is flaked in the second step, and the silver coating on the silver-coated powder is flattened smoothly and thinly through the use of a predetermined grinding medium, which will be described hereinafter, in follow of the flaking of the copper-containing powder which serves as the base material. As a result, the silver atoms in the silver coating are in an aligned state. Therefore, even though the silver coating is made thin in thickness, it is expected that the oxidation resistance and the electrical conductivity of the silver coating will be improved.

In other words, it is believed that according to the second step, the entire surface of the flake-form base material is coated with the silver coating, and the flake-form conductive filler of the present invention has a ratio a/b between a peak intensity “a” derived from a silver (111) plane and a peak intensity “b” derived from a silver (220) plane at 2 or less in the X-ray diffraction measurement.

As the grinding device having a grinding medium, it is not particularly limited. For example, a ball mill, a bead mill or the like may be given as an example. It is characterized that a spherical medium having a diameter in the range of 0.2 mm or more to 40 mm or less is adopted as the grinding medium. Adopting such grinding medium makes it possible to achieve the excellent effects as described above. More preferably, the diameter is in the range of 0.5 mm or more to 5 mm or less.

It should be noted that although it is characterized that as the grinding medium of the present invention, a spherical media having a diameter in the range of 0.2 mm or more to 40 mm or less is adopted, as long as it exhibits the effects of the present invention, any medium other than the abovementioned spherical medium may be adopted without departing from the scope of the present invention.

As the material constituting the grinding medium described above, generally ceramic beads, glass beads, steel beads or the like may be used, and the material thereof may be selected arbitrarily according to purposes. Note that the spherical medium is not limited to a medium in a real spherical shape, a medium in a substantially spherical shape is also included.

Preferably, the ratio (Dm/DB) between the diameter of the grinding medium (DB) and the average particle size of the silver-coated powder (Dm) is in the range of 0.0001 or more to 0.02 or less, and more preferably in the range of 0.002 or more to 0.01 or less. By setting the ratio within this range, it is possible to achieve the abovementioned effects more significantly.

Preferably, the average particle size (Dm) of the silver-coated powder is in the range of 0.5 μm or more to 30 μm or less, and more preferably in the range of 1 μm or more to 15 μm or less.

It is preferable that in the second step of the present invention, various grinding conditions such as the diameter of the grinding medium, the grinding time, the solvent used and the dispersing agent are controlled so that the edge portions of each particle of the flake-form conductive filler will be ground smooth without being torn off by the strong impact from the grinding medium. If a particle is torn off by the strong impact from the grinding medium, the edge portion of the flake-form base material corresponding to the portion which is torn off may not covered by the silver coating, and as a result, the electrical conductivity thereof may be degraded.

Thus, in the second step of the present invention, the strong impact from the grinding medium to the silver-coated powder is alleviated through the use of an organic solvent so as to perform the grinding (flaking) in the organic solvent while limiting the diameter and the shape of the grinding medium as that described above (or further setting the ratio between the diameter of the grinding medium and the average particle size of the silver-coated power as described above). It is expected that in the present invention, the edge portions of each particle of the flake-form conductive filler are ground smooth according to the complex effects of the abovementioned conditions.

The organic solvent described above is not particularly limited, for example, any hydrocarbon-based solvent such as a mineral spirit and a naphtha solvent, an alcohol-based solvent, an ether-based solvent and an ester-based solvent may be used. In general, on the consideration of safety such as flammability to the solvent in grinding, a hydrocarbon-based solvent with a high boiling point is preferred. It is preferred that the organic solvent is used in a range of 50 mass parts or more to 3000 mass parts or less with respect to 100 mass parts of the silver-coated powder.

The required time (grinding time) for the second step is not particularly limited, it is preferably in the range of 30 minutes or more to 30 hours or less, and more preferably in the range of 2 hours or more to 20 hours or less. If the required time is too short, it is difficult to make the flaking uniform, resulting in the silver-coated powder which has been sufficiently flaked mixed with the silver-coated powder which has not been sufficiently flaked, and thereby, the electrical conductivity of the flake-form conductive filler may be degraded. On the other hand, if the required time is too long, the economic efficiency may be reduced unfavorably.

### Preferred Production Method or the Like

In the present invention, in order to prevent defects from occurring such as preventing the silver coating from being peeled off from the surface of the flake-form base material or preventing the silver coating from being broken by the impact of the grinding medium, or preventing the aggregation of the flake-form conductive filler, it is preferable to treat the silver-coated powder by using a higher fatty acid in the first step (before performing the second step), or to flake the silver-coated powder in the presence of a higher fatty acid in the second step.

By using a higher fatty acid, the surface of the flake-form conductive filler is treated with the higher fatty acid, and thereby the abovementioned object is achieved. In addition thereto, it is also possible to prevent the silver coating on the flake-form conductive filler from being oxidized unnecessarily.

Furthermore, in the silver-coated powder formed with the silver coating through the electroless plating method in the first step, due to the diffusion of copper atoms or copper ions from the copper-containing powder into the obtained silver coating, copper atoms or copper ions may be present in the silver coating. As time passes, copper atoms or copper ions may be present on the surface of the silver-coated powder or inside the layer of the silver coating as an oxide, which thereby exerts adverse effects such as degrading the electrical conductivity or the like. The presence of copper atoms or copper ions may be reduced through the treatment with acid. However, since the flake-form base material constituting the flake-foam conductive filler may be oxidized in an acid solution in which water is used as the solvent, such acid solution is not preferable. In the present invention, a higher fatty acid dissolved in an organic solvent is used to carry out the similar functions as the acid in aqueous solution so as to reduce copper atoms or copper ions in the silver coating, and thereby it is preferable. In other words, the silver-coated powder is treated with a higher fatty acid, copper atoms or copper ions present in the silver coating are dissolved in the higher fatty acid, and thereby, the copper concentration in the silver coating is reduced. Accordingly, the oxidation caused by the presence of copper in the silver coating, the gelation caused by the reaction with resin when being formulated into the conductive paste composition can be suppressed.

Any fatty acid having carbon atoms of 12 or more, specifically, for example, lauric acid, myristic acid, palmitic acid, margaric acid, stearic acid, oleic acid, linoleic acid, linolenic acid or the like may be given as the higher fatty acid.

It should be noted that when using a higher fatty acid to perform the treatment in the first step, it is possible to perform the treatment through stirring after all of the silver-coated powder, the higher fatty acid and the organic solvent are added to the grinding device to be used in the second step. In this case, although the formulation amount of each is not particularly limited, it is preferred to formulate 0.5 mass parts or more to 30 mass parts or less of the higher fatty acid and 50 mass parts or more to 3000 mass parts or less of the organic solvent with respect to 100 mass parts of the silver-coated powder, respectively.

On the other hand, when the silver-coated powder is flaked in the presence of a higher fatty acid in the second step, although the formulation amount of the higher fatty acid is not particularly limited, it is preferable that the higher fatty is formulated at 0.5 mass parts or more to 30 mass parts or less with respect to 100 mass parts of the silver-coated powder so as to obtain sufficient lubricity and to prevent workability from being degraded.

It is obvious from the description in the above, as a preferred production method of the present invention, an embodiment where the silver-coated powder is obtained in the first step by forming the silver coating on the surface of the copper-containing powder through the electroless plating, and thereby in the second step, the silver-coated powder is flaked in the presence of a higher fatty acid may be given, or an embodiment where the silver-coated powder in the first step is treated with a higher fatty acid after the silver coating is formed through electroless plating on the surface of the copper-containing powder may be given.

As described above, the flake-form conductive filler produced according to the production method of the present invention may be applied to various applications. In other words, for example, the flake-form conductive filler produced according to the production method of the present invention may be included in a conductive paste composition, and the conductive paste composition may be used to form a conductive coating, an electrode or the like.

### EXAMPLES

Hereinafter, the present invention will be described in detail with examples, and it should be noted that the present invention is not limited to the examples.

### Example 1

First, a copper powder was used as a copper-containing powder to form a silver coating on the surface of the copper-containing powder according to the electroless plating method, and thereby a silver-coated powder was prepared (the first step).

Specifically, a dispersion liquid was prepared by dispersing 100 g of the copper powder having an average particle size of 5.1 μm in a solution which was prepared by dissolving 65 g of EDTA (ethylenediamine tetra-acetic acid) in 1 liter of water, and thereafter, 100 ml of silver nitrate solution was added to the dispersion liquid and stirred for 30 minutes. The silver nitrate solution used here was prepared in such a way that 25 g of silver nitrate was dissolved in 60 ml of aqueous ammonia solution (25 mass %) and adjusted into 100 ml by the addition of water. After the stirring, the obtained aqueous dispersion of silver-coated powder was filtered through suction and washed with water, and thereafter, it was dried in a vacuum oven at 90 ° C. to provide the dry silver-coated powder which has a silver coating formed on the surface of the copper powder through electroless plating and an average particle size (Dm) of 5.6 μm.

Subsequently, the silver-coated powder prepared in the above was flaked in an organic solvent by using a grinding device having a grinding medium to produce the flake-form conductive filler of the present invention (the second step).

Specifically, 100 g of the silver-coated powder prepared in the first step, 2 g of oleic acid which serves as the higher fatty acid, and 200 g of mineral spirit which serves as the organic solvent were added into a ball mill which serves as the grinding device, and was subjected to the flaking treatment for 3 hours by using steel balls (spherical media) of 2 mm in diameter which serve as the spherical grinding media to provide the flake-form conductive filler of the present invention. It should be noted that the ratio (Dm/DB) between the average particle size (Dm) of the silver-coated powder and the diameter (DB) of the grinding medium was 0.0028.

The flake-form conductive filler obtained thereby contains the flake-form base material and the silver coating covering the entire surface of the flake-form base material, the flake-form base material contains copper, and the flake-form conductive filler has a ratio a/b between the peak intensity “a” derived from the silver (111) plane and the peak intensity “b” derived from the silver (220) plane at 2 or less in the X-ray diffraction measurement.

### Example 2

The flake-form conductive filler of the present invention was prepared in the same manner as Example 1 except that the time for the flaking treatment in the second step in Example I was set to 6 hours.

### Comparative Example 1

The dry silver-coated powder having the average particle size of 5.6 μm prepared in the first step in Example 1 was used as the conductive filler. In comparison to the flake-form conductive filler of the present invention, the conductive filler is not in the flake form.

### Comparative Example 2

Except that the copper powder having the average particle size of 5.1 μm (which was used in Example 1) which is not subjected to the first step was used in place of the silver-coated powder prepared in the first step in Example 1, the copper powder was flaked in the same manner as the second step in Example 1.

100 g of the flake-form copper power obtained in this manner was dispersed for 5 minutes in a solution prepared by dissolving 2 g of sodium carbonate and 2 g of disodium hydrogen phosphate in 500 ml of water, filtered through suction and washed with water.

Thereafter, 100 g of the flake-form copper powder obtained above was used to produce the flake-form copper powder formed with a silver coating (conductive filler) in the same manner as the first step in Example 1

Different from the production method of the present invention, the conductive filler was produced in such a way that the base material was preliminarily flaked and the silver coating was formed thereafter.

### Comparative Example 3

Except that the silver powder having the average particle size of 5.0 μm was used in place of the silver-coated powder prepared in the first step in Example 2, the silver powder was flaked in the same manner as the second step in Example 2 to produce the flake-form silver powder (conductive filler).

In comparison to the flake-form conductive filler of the present invention, the conductive filler is equivalent to the flake-form silver powder which has been used as the conductive filler in the conventional art. By comparing the ratio a/b between the peak intensity “a” derived from the silver (111) plane and the peak intensity “b” derived from the silver (220) plane before flaking and after flaking in Comparative Example 3 mentioned above, it was confirmed that the ratio a/b after flaking was 0.19 whereas the ratio a/b before flaking was 3.24, and the ratio a/b becomes smaller through the flaking treatment.

### Evaluation

For the flake-form conductive filler of Examples 1 and 2 and the conductive filler of Comparative Examples 1 to 3, the X-ray diffraction measurement was performed thereon and the conductivity thereof was evaluated in the following manner.

### X-ray Diffraction Measurement

As to be described hereinafter, for the coating film coated on a glass plate which will be used in the evaluation of conductivity, an X-ray diffraction device (trademark: “RINT2000” by Rigaku Co., Ltd.) was used to perform the X-ray diffraction measurement thereon. The X-ray source used was Ka rays of copper.

For peaks in the chart obtained through the measurement, the ratio a/b was calculated from the relative integrated intensity between the peak intensity (a) nearby 2θ=38.4° which is equivalent to the silver (111) plane and the peak intensity (b) nearby 2θ=65.0° which is equivalent to the silver (220) plane. The result is shown in Table 1. In Table 1, “Ag powder” refers to the silver powder which was used as a raw material powder in Comparative Example 3 (and the same applies to the other items).

### Conductivity Evaluation

The coating film for the conductivity evaluation was prepared in the following manner. Specifically, the coating film was prepared satisfying such a condition that the volume ratio of the flake-form conductive filler or the conductive filler in the coating film is 60%.

More specifically, in Examples 1 and 2, and in Comparative Examples 1 and 2, a mixture of 7.87 g of the flake-form conductive filler or the conductive filler and 3.00 g of a resin solution (trademark: “Nippe Acrylic Autoclear Super” by Nippon Paint Co., Ltd.) was coated on a PET film by using an applicator and dried for 30 minutes at 100 ° C. to form the coating film in such a way that the thickness of the coating film after drying is about 30 μm.

In Comparative Example 3, a mixture of 9.05 g of the conductive filler and 3.00 g of the resin solution (same as the above one) was coated on a PET film by using an applicator and dried for 30 minutes at 100 ° C. to form the coating film in such a way that the thickness of the coating film after drying is about 30 μm.

For each of the coating films fabricated in the above, the specific resistance (Ω·cm) was measured using a low resistivity meter (trademark: “Loresta GP” by Mitsubishi Chemical analyTech Co., Ltd.). The average particle size D₅₀ (μm) and the average thickness t (pm) of the obtained conductive filler were measured and the aspect ratio was calculated therefrom (however, the average thickness and the aspect ratio were not calculated for Comparative Example 1 and for the Ag powder). The results are shown in Table 1. It should be noted that the smaller the specific resistance is, the better the conductivity will be.

Furthermore, the temporal change of the specific resistivity was measured for the coating film of Example 2 and for the coating film of Comparative Example 2. Specifically, the specific resistance (0.cm) of each coating film was measured after it was retained at a relative humidity of 85% and a temperature of 85 ° C. for 500 hours, 1000 hours, 1500 hours, 2000 hours, and 2500 hours, respectively. The results are shown in Table 2.

TABLE 1

| | Average | | | | Peak | Peak | | Specific |
|---|---|---|---|---|---|---|---|---|
| | Particle | | Average | Aspect | intensity | intensity | Ratio | Resistance |
| | size D₅₀ | | Thickness t | Ratio | “a” | “b” | a/b | (Ω · cm) |
| Example 1 | 10.3 | μm | 2.8 μm | 3.68 | 31.06 | 22.01 | 1.41 | 1.0 × 10⁻⁴ |
| Example 2 | 13.8 | μm | 1.2 μm | 11.46 | 28.18 | 25.43 | 1.11 | 4.80 × 10⁻⁵ |
| Comparative | 5.6 | μm | — | — | 24.43 | 7.80 | 3.13 | 1.20 × 10⁻² |
| Example 1 | | | | | | | | |
| Comparative | 10.2 | μm | 2.9 μm | 3.52 | 37.49 | 17.26 | 2.17 | 4.43 × 10⁻⁴ |
| Example 2 | | | | | | | | |
| Comparative | 15.2 | μm | 1.1 μm | 13.8 | 19.24 | 100 | 0.19 | 3.90 × 10⁻⁵ |
| Example 3 | | | | | | | | |
| Ag Powder | 5.0 | μm | — | — | 100 | 30.90 | 3.24 | 1.14 × 10⁻³ |

TABLE 2

| | After | After | After | After | After |
|---|---|---|---|---|---|
| | 500 hrs | 1000 hrs | 1500 hrs | 2000 hrs | 2500 hrs |
| Example 2 | 3.0 × 10⁻⁵ | 3.3 × 10⁻⁵ | 3.4 × 10⁻⁵ | 3.6 × 10⁻⁵ | 3.9 × 10⁻⁵ |
| Comparative | 2.4 × 10⁻⁴ | 2.5 × 10⁻⁴ | 3.0 × 10⁻⁴ | 3.8 × 10⁻⁴ | 4.9 × 10⁻⁴ |
| Example 2 | | | | | |

As obviously seen from Table 1, it was confirmed that the flake-form conductive filler of each Example has excellent conductivity compared to the conductive filler of Comparative Examples 1 and 2. It is considered that the flake-form conductive filler of each Example has excellent conductivity because the ratio a/b of the flake-form conductive filler of each Example relative to the conductive filler of Comparative Examples 1 and 2 is at 2 or less and thereby the silver atoms in the silver coating are in an aligned state.

Moreover, as obviously seen from Table 2, with respect to the fact that in Example 2 the specific resistance after 500 hours was increased to about 1.3 times of the specific resistance after 2500 hours, the specific resistance was increased to about 2.0 times in Comparative Example 2. The increase in specific resistance is considered to be caused by the progress of surface oxidation, thus it was confirmed that the flake-form conductive filler of the Example has oxidation resistance superior to the conductive filler of the Comparative Example.

The reason why the comparison is made with emphasis on the data after the time has elapsed for 500 hours and thereafter rather than the data at the initial time in Table 2 will be described in the following.

Since the resin (binder) in the currently used resin solution has low moisture and heat resistance, it is considered that in measuring the temporal change of the specific resistance the resin will deteriorate greater after the time has elapsed for 500 hours than at the initial time and thus the number of contact points where the conductive fillers contact each other in the coating film will increase, and consequently the specific resistance in Table 1 will take a smaller value than the initial specific resistance.

Therefore, it is not appropriate to evaluate the temporal change of the conductive filler with the comparison of the initial values since the deterioration of the resin will exert greater influence on the specific resistance.

On the other hand, after 500 hours the resin will not deteriorate any further, the temporal change of the conductive filler will exert greater influence on the specific resistance.

Accordingly, in evaluating the temporal change of the conductive filler in Table 2, it is considered that evaluating the transitional change of the specific resistance after 500 hours as the performance change of the conductive filler with time is appropriate.

Although the embodiments and the examples of the present invention have been explained in the above, any appropriate combination of each embodiment and each example explained in the above has been taken into consideration from the very beginning.

It should be understood that the embodiments disclosed herein have been presented for the purpose of illustration and description but not limited in all aspects. It is intended that the scope of the present invention is not limited to the description above but defined by the scope of the claims and encompasses all modifications equivalent in meaning and scope to the claims.

1. A flake-form conductive filler comprising a flake-form base material and a silver coating covering the entire surface of said flake-form base material,
said flake-form base material containing copper, and
said flake-form conductive filler having a ratio a/b between a peak intensity “a” derived from a silver (111) plane and a peak intensity “b” derived from a silver (220) plane at 2 or less in the X-ray diffraction measurement.

2. The flake-form conductive filler according to claim 1, wherein said flake-form conductive filler has an average aspect ratio of an average particle size D₅₀ relative to an average thickness t at 1.5 or more to 500 or less.

3. The flake-form conductive filler according to claim 2, wherein said average aspect ratio is greater than 10 and equal to 50 or less.

4. A conductive paste composition comprising the flake-form conductive filler according to claim 1.

5. A conductive product produced by using the conductive paste composition according to claim 4.

6. A production method of a flake-form conductive filler, comprising:
a first step of preparing silver-coated powder which has a silver coating formed on the surface of copper-containing powder; and
a second step of flaking said silver-coated powder in an organic solvent by using a grinding device equipped with a grinding medium, said grinding medium used in said second step being a spherical medium having a diameter ranging from 0.2 mm or more to 40 mm or less.

7. The production method of a flake-form conductive filler according to claim 6, wherein
said silver-coated powder in said first step is obtained by forming a silver coating on the surface of said copper-containing powder through electroless plating, and
said silver-coated powder is flaked in said second step in the presence of a higher fatty acid.

8. The production method of a flake-form conductive filler according to claim 6, wherein said silver-coated powder in said first step is treated with a higher fatty acid after the silver coating is formed through electroless plating on the surface of said copper-containing powder.
